(19) United States
(12) Patent Application Publication
(10) Pub. No.: US 2022/0209424 A1
(43) Pub. Date: Jun. 30, 2022

(54) VEHICLE-MOUNTED MILLIMETER WAVE RADAR ARRAY ANTENNA

(71) Applicant: SHANGHAI BAOLONG AUTOMOTIVE CORPORATION, Shanghai (CN)

(72) Inventors: Changwu XU, Shanghai (CN); Wei LI, Shanghai (CN)

(21) Appl. No.: 17/607,328

(22) PCT Filed: Apr. 29, 2019
(86) PCT No.: PCT/CN2019/085028

§ 371 Date: Oct. 28, 2021

(51) Int. Cl. H01Q 21/06; H01Q 1/38; H01Q 1/32

(52) U.S. Cl. CPC H01Q 21/064; H01Q 1/32; H01Q 1/38

(57) ABSTRACT

The present invention relates to a vehicle-mounted millimeter wave radar array antenna. The vehicle-mounted millimeter wave radar array antenna comprises: a plurality of horn units; an SIW antenna array composite layer, which comprises an SIW structure-based power divider formed on a high frequency material, wherein the horn units are arranged on the SIW antenna array composite layer; and a signal input/output layer. A transmission signal is transmitted from the signal input/output layer to the SIW antenna array composite layer, the power divider divides the transmission signal into multiple transmission signals, and the multiple transmission signals are radiated outwards by means of corresponding horn units. Provided in the present invention is a vehicle-mounted millimeter wave radar array antenna, which has the characteristics of having a small volume, being light-weight, featuring simple processing and having low fabrication costs.

### TECHNICAL FIELD

The present invention relates to the technical field of antennas, in particular to a vehicle-mounted millimeter wave radar array antenna.

### BACKGROUND

With a gradual improvement of safety awareness of people, vehicle-mounted millimeter wave anti-collision radar, as a prevention system for safety, has developed rapidly. The advantages such as small structure, light weight, strong environmental adaptability, stability and reliability thereof, have been highlighted in the application of vehicle-mounted anti-collision radar. Vehicle-mounted anti-collision radar is mainly used to detect objects and targets around the vehicle, and gives prompts and previous safety warnings according to the surrounding targets, so as to ensure driving safety. Vehicle-mounted millimeter wave radar senses the environment through millimeter wave, such as detecting the distance between front and rear vehicles, and the lane marking, etc.

At present, there are several antenna array schemes used in vehicle-mounted millimeter wave radar at home and abroad:

(1) Microstrip antenna: the antenna has advantages of simple structure, low price and various forms (such as rectangle, square, triangle, circle and ellipse, etc.). The structure of this antenna is simple, while the shortcomings thereof comprise low antenna gain and narrow bandwidth, needing a larger area than other antenna types with the same parameters, as well as requiring a very high manufacturing accuracy of microstrip line in the millimeter wave band.

(2) Slot antenna: the antenna is a kind of antenna that can realize electromagnetic, wave leakage by opening some slots on a metal plane, so as to realize antenna radiation. The antenna has advantages of high gain and easy designing. The disadvantages thereof are that the antenna uses heavy structural parts, the size of the antenna is large, the feed network is complex, the processing implementation is difficult, and it is not easy to produce in a large quantity.

(3) Slot horn antenna of plastic electroplating process: the antenna is a kind of structure that uses the plastic electroplating process with light material to realize waveguide feeding and horn antenna through a laminated structure. The advantages thereof comprise light weight, high gain and narrow beam. However, the manufacturing process of the array antenna is complex, the thickness of the coating on the plastic surface is difficult to control, and the plastic is greatly affected by temperature, which restricts the mass production of this kind of antenna. In addition, due to the high height of this array antenna, it cannot meet the needs of increasingly miniaturized system products.

The above array antennas cannot meet the requirements of small structure, light weight and simple manufacturing process. Their large volume and complex process seriously restrict the development of miniaturization and mass production of vehicle-mounted millimeter wave radar.

### SUMMARY

In view of the above problems of the prior art, the present invention provides a vehicle-mounted millimeter wave radar array antenna, which has compact overall structure and has the characteristics of small volume, light weight, simple process and low cost under the same performance parameters.

Specifically, the present invention provides a vehicle-mounted millimeter radar array antenna, comprising:

a plurality of horn units;

a composite layer of SIW antenna array, comprising an SIW structure-based power divider formed on a high frequency material, wherein the horn units are arranged on the composite layer of SIW antenna array;

a signal input and output layer;

wherein a transmission signal is transmitted from the signal input and output layer to the composite layer of SIW antenna array, the power divider divides the transmission signal into a plurality of transmission signals, and the plurality of transmission signals are radiated outward through the corresponding plurality of horn units.

According to an embodiment of the present invention, each of the horn units comprises a waveguide transmission layer, an intermediate radiation layer and a radiation slot layer. The plurality of transmission signals sequentially pass through the waveguide transmission layer and the intermediate radiation layer, and radiates outward from the radiation slot layer to a free space, through the corresponding plurality of horn units. to According to an embodiment of the present invention, a plurality of via slots are arranged on the radiation slat layer. The plurality of transmission signals are radiated outward through the via slots.

According to an embodiment of the present invention, the plurality of horn units have a same structure and a same signal bandwidth.

According to an embodiment of the present invention, each waveguide transmission layer of the plurality of horn units is isolated from each other.

According to an embodiment of the present invention, the intermediate radiation layer and/or the waveguide transmission layer are made of FR-4 material.

According to an embodiment of the present invention, the radiation slot layer is made of FR-4 material.

According to an embodiment of the present invention, the intermediate radiation layer is provided with a metallized through hole, and the intermediate radiation layer realizes a radiation function through the metallized through hole.

According to an embodiment of the present invention, the high-frequency material is a high-frequency PCB.

The vehicle-mounted millimeter wave radar array antenna according to the present invention, combines SIW technology with horn antenna, so that the vehicle-mounted millimeter wave radar array antenna can meet the technical requirements of small volume, light weight, high strength and low cost, and has low overall manufacturing process accuracy requirements, high gain and narrow beam.

It should be understood that the above general description and the following detailed description of the present invention are exemplary and illustrative, and are intended to provide further explanation for the invention as claimed in the claims.

### BRIEF DESCRIPTION OF THE DRAWINGS

The features and performance of the present invention are further described by the following embodiments and the accompanying drawings.

FIG. 1 shows a structural diagram of a vehicle-mounted millimeter wave radar array antenna according to an embodiment of the present invention.

FIG. 2 is an exploded view of FIG. 1. to FIG. 3 shows a diagram of simulated electromagnetic field transmission of a radiation slot layer according to an embodiment of the present invention.

FIG. 4 shows a diagram of simulated electromagnetic field transmission of an intermediate radiation layer according to an embodiment of the present invention.

FIG. 5 shows a diagram of simulated electromagnetic field transmission of a waveguide transmission layer according to an embodiment of the present invention.

FIG. 6 shows a structural diagram of a composite layer of SIW antenna array according to an embodiment of the present invention.

FIG. 7 shows a diagram of simulated electromagnetic field transmission of a composite layer of SIW antenna array according to an embodiment of the present invention.

Wherein, the above drawings comprise the following reference signs:

| | |
|---|---|
| vehicle-mounted millimeter wave radar array antenna | 100 |
| horn unit | 110 |
| radiation slot layer | 111 |
| intermediate radiation layer | 112 |
| waveguide transmission layer | 113 |
| composite layer of SIW antenna array | 120 |
| signal input and output layer | 130 |

### DETAILED DESCRIPTION OF EMBODIMENTS

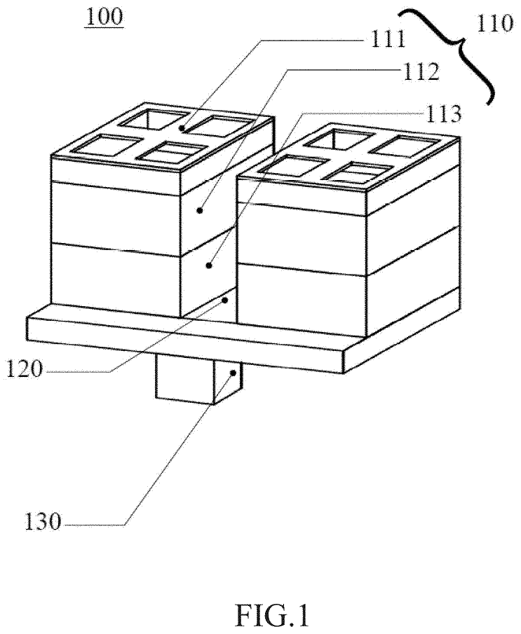

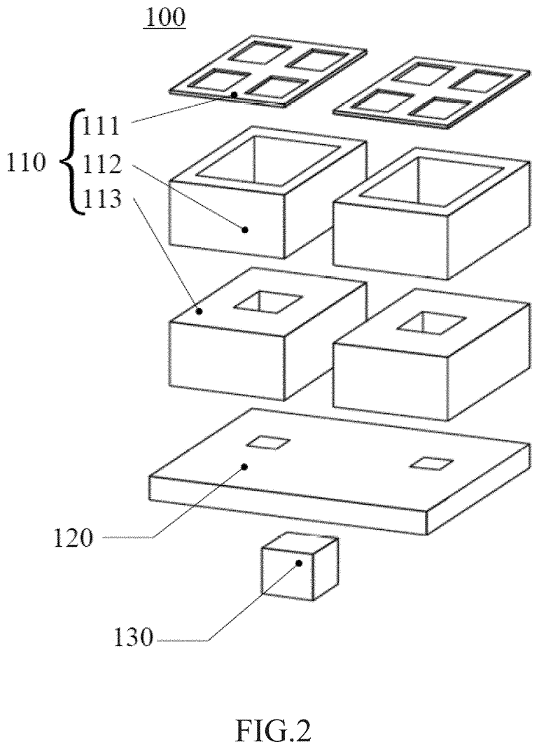

FIG. 1 shows a structural diagram of a vehicle-mounted millimeter wave radar array antenna according to an embodiment of the present invention. FIG. 2 is an exploded view of FIG. 1. As shown in the figures, the vehicle-mounted millimeter wave radar array antenna 100 comprises a plurality of horn units 110, a composite layer of SIW antenna array 120 and a signal input and output layer 130.

Wherein the composite layer of SIW antenna array 120 comprises a power divider, based on a SIW structure, which is formed on a high-frequency material. SIW (substrate integrated waveguide) is a kind of transmission line between microstrip and dielectric filled waveguide, SIW takes into account the advantages of traditional to waveguide and microstrip transmission line, and can realize high-performance microwave and millimeter wave planar circuits. The power divider here is a device that can divide one input signal energy into two or more channels of output with equal or unequal energy (but it can also be carried out in reverse, which can also be called combiner at this time). According to the output, the power divider is usually divided into forms such as one-to-two (one input and two outputs), one-to-three (one input and three outputs) or one-to-many (one input and multiple outputs). As an example rather than a limitation, in the present embodiment, the composite layer of SIW antenna array 120 adopts a power divider in the form of one-in-two, that is, dividing one transmission signal into two channels of transmission signals. As an example rather than a limitation, the high-frequency material here adopts a high-frequency PCB, Polytetrafluoroethylene (PTEF) high-frequency antenna plate or high-frequency ceramic plate can also be selected as the high-frequency material.

The horn units 110 are arranged on the composite layer of SIW antenna array 120. It is easy to understand that when a one-to-two power divider is adopted, two horn units 110 need to be set on the composite layer of SIW antenna array 120 to transmit two channels of transmission signals respectively.

During the operation of the vehicle-mounted millimeter wave radar array antenna 100, the transmission signal (electromagnetic wave) is transmitted from the signal input and output layer 130 to the composite layer of SIW antenna array 120. The power divider on the composite layer of SIW antenna array 120 divides the transmission signals into two channels. The two channels of transmission signals radiate outward through two corresponding horn units 110.

Further, each horn unit 110 comprises a waveguide transmission layer 113, an intermediate radiation layer 112 and a radiation slot layer 111. Each channel of the transmission signal passes through a corresponding horn unit 110. The transmission signal passes through the waveguide transmission layer 113 and the intermediate radiation layer 112 of the horn unit 110 in sequence, and radiates outward into a free space through the radiation slot layer 111. Wherein, the waveguide transmission layer 113 is responsible for transmitting the transmission signal from the power divider to the intermediate radiation layer 112. The intermediate radiation layer 112 better to realizes the radiation of the transmission signal through its horn structure. The radiation slot layer has a function of array formation, and can efficiently radiate the transmission signal outward.

The vehicle-mounted millimeter wave radar array antenna 100 provided in the present invention adopts a PCB transmission mode based on SIW technology and is combined with a radiation mode of the horn unit 110 to greatly reduce the manufacturing accuracy problems in the manufacturing process and improve the yield of the array antenna. Specifically, the structure can greatly reduce the area of the array antenna by using the characteristics of SIW structure. In addition, the horn unit structure can achieve a bandwidth of about 10 GHz in automotive millimeter wave band, which is much higher than the 1-3 GHz bandwidth of microstrip and ordinary slot antennas in the prior art, thereby reducing the accuracy requirements of the manufacturing process.

Preferably, a plurality of via slots are provided on the radiation slot layer 111 of the horn unit 110. The transmission signal radiates outward through the via slots. The setting of the plurality of via slots realizes the array formation function of the radiation slot layer.

Preferably, in the present embodiment, the two horn units 110 have the same structure and the same signal bandwidth.

Preferably, in the present embodiment, the two waveguide transmission layers 113 of the two horn units 110 are isolated from each other to ensure that the transmission signals in their respective channels can be transmitted normally without affecting each other.

Preferably, the intermediate radiation layer 112 and/or the waveguide transmission layer 113 in the horn unit 110 are made of FR-4 material. FR-4 is a code for the grade of flame resistant material, which represents a material specification that the resin material must be able to extinguish itself after combustion. It is not a material name, but a material grade. Therefore, there are many kinds of FR-4 grade materials used for general circuit boards at present, while most of them are composites made of epoxy resin, filler and glass fiber. FR-4 has high mechanical and dielectric properties, good heat and moisture resistance, and good machinability. Light FR-4 material is selected here to reduce the overall weight. Because of the hard characteristics of FR-4 material, the strength of the whole radar array antenna can be further increased. In addition, in terms of process, FR-4 material can be directly pressed with PCB material to reduce process difficulty and assembly cost.

Preferably, the radiation slot layer is made of FR-4 material, and the principle is the same as above. In fact, the radar array antenna with horn unit 110 mainly made of FR-4 material has simpler manufacturing process and lower accuracy requirements than high-frequency plate and metal material of about 0.1 mm. At the same time, under the condition of the same array antenna performance, the volume of the radar array antenna provided by the present invention is reduced by nearly 50% compared with other types of antennas.

Preferably, the middle radiation layer 112 of the horn unit 110 is provided with a metallized through hole, and the middle radiation layer 112 realizes its radiation function through the metallized through hole.

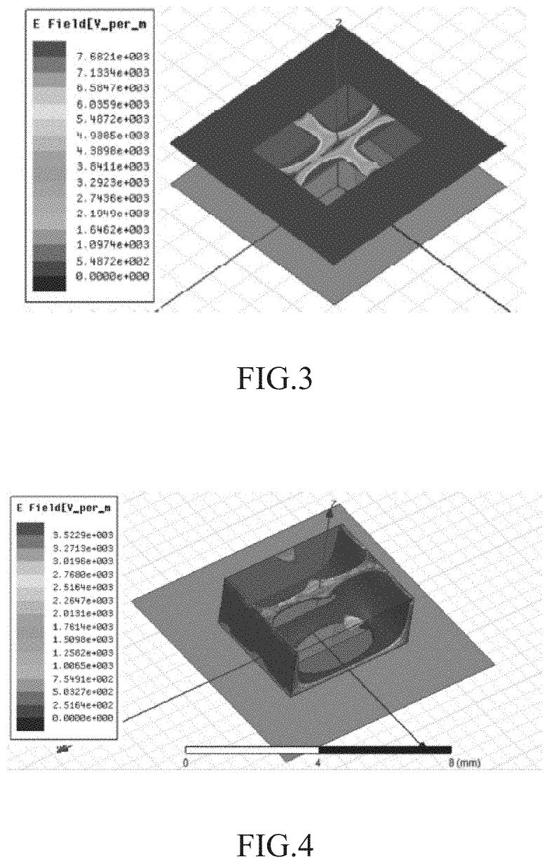

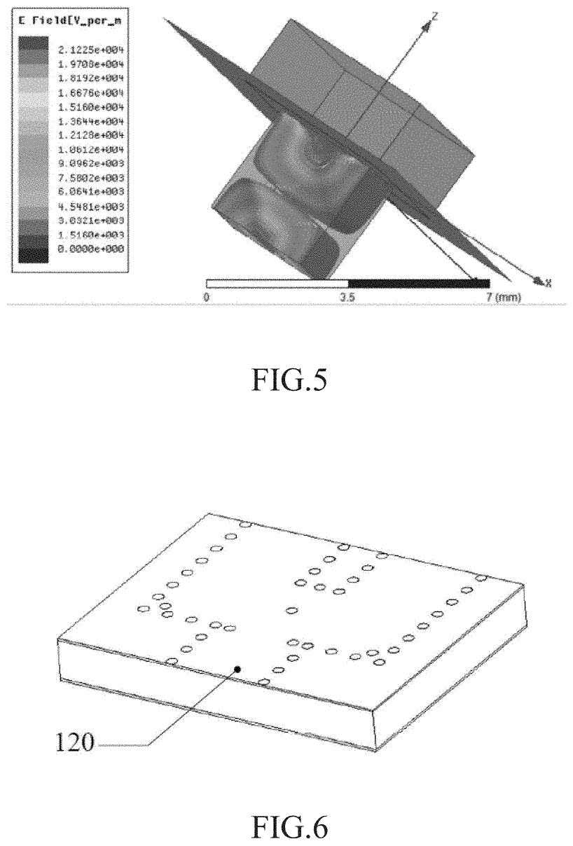

FIG. 3 shows a diagram of simulated electromagnetic field transmission of a radiation slot layer according to an embodiment of the present invention. At the end surface of the horn unit, the transmission signal (electromagnetic wave) is transmitted to the space by the radiation unit. The figure shows the distribution state of electromagnetic wave in the radiation unit. FIG. 4 shows a diagram of simulated electromagnetic field transmission of an intermediate radiation layer according to an embodiment of the present invention, showing the distribution state of the electromagnetic wave in the intermediate radiation layer 112. FIG. 5 shows a diagram of simulated electromagnetic field transmission of a waveguide transmission layer according to an embodiment of the present invention, showing the distribution state of the electromagnetic wave in the waveguide transmission layer 113.

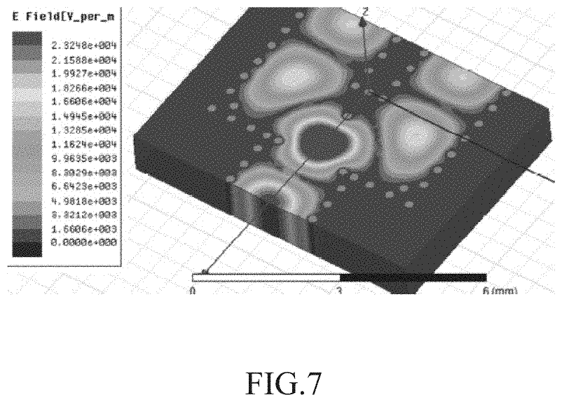

FIG. 6 shows a structural diagram of a SIW power divider according to an embodiment of the present invention. The power divider is in the form of SIW, which is similar to a dielectric filled metal waveguide. As shown in the figure, the upper and lower planes of the composite layer of SIW antenna array 120 are metal layers, and the middle is a dielectric layer. The upper and lower metal layers are connected by the metallized through holes 121. By selecting an appropriate hole spacing, the signal can be bounded in the “channel” surrounded by the through holes. By adjusting the position of the metallized through holes 121, the characteristic impedance there can be changed, so as to play a role of impedance matching. The structure of the composite layer of SIW antenna array 120 can not only distribute the signal of the signal input and output layer 130 (the input port) to the, waveguide transmission layer 113 (the output port) according to a certain power ratio, but also filter out low-frequency interference signals. FIG. 7 shows a diagram of simulated electromagnetic field transmission of a composite layer of SIW antenna array according to an embodiment of the present invention, and FIG. 7 shows the transmission state of the electromagnetic waves in the composite layer of SIW antenna array 120.

The vehicle-mounted millimeter wave radar array antenna according to the present invention, combines SIW technology with horn antenna, so that the vehicle-mounted millimeter wave radar array antenna can meet the technical requirements of small volume, light weight, high strength and low cost, and has low overall manufacturing process accuracy requirements, high gain and narrow beam. By using the power divider function of SIW technology, one transmission signal is divided into a plurality channels of transmission signals, and combined with the plurality of corresponding horn units, so as to realize the free array formation of the antenna array. Due to the use of horn unit structure, the bandwidth of the radar array antenna can achieve about 10 GHz bandwidth in automotive millimeter wave band, which can well cover the use frequency band of the anti-collision millimeter wave radar of automobile, and ensure the stable operation of radar system and the manufacturing complexity of products, thereby making the vehicle-mounted millimeter wave radar meet the requirements of small volume, light weight, high strength, low cost, high gain, narrow beam width, and low process accuracy requirements, etc.

It will be apparent to those skilled in the art that various modifications and variations can be made to the above exemplary embodiments of the present invention without departing from the spirit and scope of the invention. Therefore, the present invention is intended to cover the modifications and variations of the invention that fall within the scope of the appended claims and their equivalent technical proposals.

1. A vehicle-mounted millimeter wave radar array antenna, comprising:
a plurality of horn units;
a composite layer of SIW antenna array, comprising a SIW structure-based power divider formed on a high frequency material, wherein the horn units are arranged on the composite layer of SIW antenna array;
a signal input and output layer;
wherein a transmission signal is transmitted from the signal input and output layer to the composite layer of SIW antenna array, the power divider divides the transmission signal into a plurality of transmission signals, and the plurality of transmission signals are radiated outward through the corresponding plurality of horn units.

2. The vehicle-mounted millimeter wave radar array antenna of claim 1, wherein each of the horn units comprises a waveguide transmission layer, an intermediate radiation layer and a radiation slot layer, and the plurality of transmission signals sequentially pass through the waveguide transmission layer and the intermediate radiation layer, and radiates outward from the radiation slot layer to a free space, through the corresponding plurality of horn units.

3. The vehicle-mounted millimeter wave radar array antenna of claim 2, wherein a plurality of via slots are arranged on the radiation slot layer, and the plurality of transmission signals are radiated outward through the via slots.

4. The vehicle-mounted millimeter wave radar array antenna of claim 1, wherein the plurality of horn units have a same structure and a same signal bandwidth.

5. The vehicle-mounted millimeter wave radar array antenna of claim 2, wherein each waveguide transmission layer of the plurality of horn units is isolated from each other.

6. The vehicle-mounted millimeter wave radar array antenna of claim 2, wherein the intermediate radiation layer and/or the waveguide transmission layer are made of FR-4 material.

7. The vehicle-mounted millimeter wave radar array antenna of claim 2, wherein the radiation slot layer is made of FR-4 material.

8. The vehicle-mounted millimeter wave radar array antenna of claim 2, wherein the intermediate radiation layer is provided with a metallized through hole, and the intermediate radiation layer realizes a radiation function through the metallized through hole.

9. The vehicle-mounted millimeter wave radar array antenna of claim 1, wherein the high-frequency material is a high-frequency PCB.
